(19) United States
(12) Patent Application Publication
(10) Pub. No.: US 2003/0104215 A1
(43) Pub. Date: Jun. 5, 2003

(54) Carbodiimides in emulsion polymerisates

(76) Inventors: Ulrike Licht, Mannheim (DE); Karl Haberle, Speyer (DE); Christian Lach, Bad Durkheim (DE); Sabine Kielhorn-Bayer, Maxdorf (DE); Karl-Heinz Schumacher, Neustadt (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/168,084

(22) PCT Filed: Dec. 6, 2000
(86) PCT No.: PCT/EP00/12279

(30) Foreign Application Priority Data
Dec. 17, 1999 (DE) 199 60 864.4

(51) Int. Cl. C08L 33/00; C08K 3/00; C08J 3/00; C08F 283/00; C08L 61/06; C08G 77/04; C08F 8/00; C08L 75/00; B32B 27/00; B32B 27/40; B32B 27/08

(52) U.S. Cl. 428/423.1; 525/501; 528/26; 525/131; 524/522; 428/474.4

(57) ABSTRACT

An aqueous dispersion of a polymer synthesized from free-radical polymerizable compounds (monomers), wherein the dispersed polymer particles comprise compounds containing carbodiimide groups (carbodiimides for short) and the carbodiimides are not attached to the polymer by free-radical copolymerization.

The invention relates to an aqueous dispersion of a polymer synthesized from free-radically polymerizable compounds (monomers), wherein the dispersed polymer particles comprise compounds containing carbodiimide groups (carbodiimides for short) and the carbodiimides are not attached by free-radical copolymerization to the polymer.

The invention further relates to processes for preparing the aqueous dispersion and to its use as a binder.

Carbodiimide groups react with carboxylic acid groups to give an N-acylurea compound. Carbodiimide compounds are therefore suitable as crosslinkers for polymers containing carboxyl groups.

From EP-A-686 626 it is known to add water-soluble carbodiimides as crosslinkers to the aqueous phase of emulsion polymers. A disadvantage of this procedure is that it is first necessary to convert the carbodiimides to a water-soluble form by appropriate reaction with, for example, ionic compounds. Moreover, the storage stabilities of the aqueous dispersions are inadequate. Processing can be carried out at best in the form of a 2-component (2K) system.

Alternatively, in accordance with Hung H. Pham and Mitchell A. Winnik Macromolecules 32 (1999), 7692-7695, copolymerizable carbodiimides may be used as comonomers in emulsion polymerization. The resulting emulsion polymers are then crosslinkable with carboxyl groups. The preparation of such copolymerizable carbodiimides is also described, for example, in EP-A-808828. In this case as well, a complex chemical synthesis is required in order to prepare suitable carbodiimides having a polymerizable ethylenically unsaturated group.

It is an object of the present invention to provide carbodiimide-crosslinkable polymer dispersions using simple carbodiimides as obtainable from customary isocyanates with elimination of carbon dioxide. The aqueous dispersions are to be stable on storage and have good performance properties.

We have found that this object is achieved by the aqueous dispersion defined at the outset and by processes for preparing the dispersion, and by the use of the dispersion as a binder.

The carbodiimides present in the aqueous dispersion in accordance with the invention are known per se and are described, for example, in Wo 99/06460.

They comprise compounds having at least one carbodiimide group of the formula —N═C═N—. The carbodiimides in the context of the present invention contain no polymerizable ethylenically unsaturated groups. The carbodiimides preferably contain from 1 to 20 carbodiimide groups.

The carbodiimides preferably have a water solubility of less than 100 g, in particular less than 50 g, and with particular preference less than 10 g, or less than 1 g per liter of water at 21° C.

The number-average molecular weight Mₙ is preferably from 100 to 10,000, with particular preference 200 to 5000, and with very particular preference from 500 to 2000 g/mol.

The number-average molecular weight is determined by means of endgroup analysis of the diisocyanates (i.e., consumption of the isocyanate groups as a result of carbodiimide formation; see below) or, if endgroup analysis is not possible, by means of gel permeation chromatography (polystyrene standard, THF as eluent).

Carbodiimide groups are obtainable in a simple manner from two isocyanate groups, with elimination of carbon dioxide:

—R—N═C═O+O═C═N—R

→—R—N═C═N—R—+CO₂

Starting from diisocyanates, therefore, oligomeric compounds are obtainable having two or more carbodiimide groups and, if desired, isocyanate groups, especially terminal isocyanate groups.

The remaining isocyanate groups may be reacted further with, for example, alcohols, thiols, or primary or secondary amines, to form urethane, thiourethane, or urea groups. Preferably, the alcohols, thiols and primary and secondary amines contain no functional groups other than hydroxyl groups, thiol groups, and primary and secondary amino groups, respectively. The carbodiimides may therefore contain isocyanate groups and their abovementioned reaction products.

The carbodiimides preferably contain no ionic groups and no polyalkylene oxide groups having more than 5 ethylene oxide units; in particular and in general, they contain no polyalkylene oxide groups having more than 5 alkylene oxide units. With very particular preference, they contain neither ionic groups nor alkylene oxide groups.

With particular preference, the carbodiimides consist of the carbodiimide groups, hydrocarbon groups and, if desired, isocyanate groups and/or their reaction products with hydroxyl, thiol or primary or secondary amino groups.

Preference is given to carbodiimides obtainable by elimination of carbon dioxide from polyisocyanates, especially diisocyanates.

Suitable diisocyanates include, for example, diisocyanates X(NCO)₂, X being an aliphatic hydrocarbon radical having 4 to 12 carbon atoms, a cycloaliphatic or aromatic hydrocarbon radical having 6 to 15 carbon atoms, or an araliphatic hydrocarbon radical having 7 to 15 carbon atoms. Examples of diisocyanates of this kind are tetramethylene diisocyanate, hexamethylene diisocyanate, dodecamethylene diisocyanate, 1,4-diisocyanato-cyclohexane, 1-isocyanato-3,5,5-trimethyl-5-isocyanato-methylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4′-diiso-cyanatodiphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI), such as the trans/trans, the cis/cis and the cis/trans isomers, and mixtures of these compounds.

The total amount of carbodiimide is preferably chosen such that there are from 0.0001 to 2 mol, in particular from 0.001 to 2 mol, with particular preference from 0.01 to 2 mol, and with very particular preference from 0.025 to 1 mol, of carbodiimide groups per kg of polymer. A particularly preferred range is also from 0.05 to 1 or up to 0.5 mol.

The dispersed polymer comprises a polymer obtainable by addition polymerization from free-radically polymerizable compounds (monomers).

The polymer is preferably synthesized to the extent of at least 40% by weight, with particular preference at least 60% by weight, from principal monomers selected from C₁-C₂₀ alkyl (meth)acrylates, vinyl esters of carboxylic acids containing up to 20 carbon atoms, vinylaromatic compounds of up to 20 carbon atoms, ethylenically unsaturated nitriles, vinyl halides, vinyl ethers of alcohols containing 1 to 10 carbon atoms, aliphatic hydrocarbon atoms having 2 to 8 carbon atoms and 1 or 2 double bonds, or mixtures of these monomers.

Examples which may be mentioned include (meth)acrylic acid alkyl esters having a C₁-C₁₀ alkyl radical, such as methyl methacrylate, methyl acrylate, n-butyl acrylate, ethyl acrylate, and 2-ethylhexyl acrylate.

Also particularly suitable are mixtures of the (meth)acrylic acid alkyl esters.

Examples of vinyl esters of carboxylic acids having 1 to 20 carbon atoms are vinyl laurate, vinyl stearate, vinyl propionate, Versatic acid vinyl ester, and vinyl acetate.

Suitable vinyl aromatic compounds include vinyl toluene, α- and p-methylstyrene, α-butylstyrene, 4-n-butylstyrene, 4-n-decylstyrene and, preferably, styrene.

Examples of nitrites are acrylonitrile and methacrylonitrile.

The vinyl halides are chlorine-, fluorine- or bromine-substituted, ethylenically unsaturated compounds, preferably vinyl chloride and vinylidene chloride.

Examples of vinyl ethers that may be mentioned include vinyl methyl ether and vinyl isobutyl ether. Preference is given to vinyl ethers of alcohols containing 1 to 4 carbon atoms.

Hydrocarbons having 2 to 8 carbon atoms and two olefinic double bonds that may be mentioned include butadiene, isoprene and chloroprene; those with one double bond are, for example, ethene or propene.

In addition to these principal monomers the polymer may comprise further monomers, examples being hydroxyl-containing monomers, especially C₁-C₁₀ hydroxyalkyl (meth)acrylates, (meth)acrylamide, ethylenically unsaturated acids, especially carboxylic acids, such as (meth)acrylic acid or itaconic acid, and their anhydrides, dicarboxylic acids and their anhydrides or monoesters, e.g., maleic acid, fumaric acid, and maleic anhydride.

At least some of the acid groups in the polymer are preferably present not initially in free form, since they crosslink with the carbodiimides. Where acid groups are required in the polymer, they may be blocked by means of chemical reaction, by esterification or etherification, for example, or simply neutralized by adding a base, examples being alkali metal hydroxides such as NaOH. Particularly suitable for this purpose are bases volatile at 21° C., such as ammonia, which can be easily separated off later on or which escape in the course of subsequent use. Following removal of the blocking agent or base, the free acid is present, and crosslinking with the carbodiimide groups is able to take place.

The aqueous dispersion is prepared preferably by means of emulsion polymerization.

For this purpose, the carbodiimides, preferably as a mixture with the monomers, are emulsified in water with the aid of a surface-active substance.

In particular, monomers containing carboxylic acid groups are at least partially neutralized, or the carboxylic acid groups are blocked, before adding the carbodiimides. In this context it is by no means necessary to block or neutralize all of the carboxylic acid groups. Following the addition of the carbodiimides, there is a reaction between the carbodiimide groups and the free carboxylic acid groups present, thereby bringing about subsequent crosslinking (i.e., after polymerization has taken place) within the dispersed polymer particle. “Internal” crosslinking of this kind contributes to the development of good performance properties: in the case of adhesives, good tensile strength and elongation at break in particular. It has proven particularly advantageous if from 10 to 90 mol %, with particular preference from 30 to 70 mol %, with very particular preference from 40 to 60 mol %, of the total carbodiimide groups originally present react at this stage with carboxylic acid groups of the monomers, so establishing an appropriate proportion of reactive carboxylic acid groups. The desired proportion of reactive carboxylic acid groups is determined, for example, in a simple manner by way of the degree of neutralization.

In the case of emulsification in water, emulsified monomer droplets having a diameter of up to 50 μm are produced; the carbodiimides are present in solution or dispersion in these monomer droplets. In the case of the customary emulsion polymerization, polymerization takes place outside these monomer droplets in the micelles formed by the surface-active substance, which are smaller by at least one order of magnitude than the monomer droplets.

It is therefore necessary for the monomers and carbodiimides to diffuse through the water phase to the site of polymerization. Although the carbodiimides are very hydrophobic, it is possible to ascertain that, after the emulsion polymerization, the carbodiimides are present as desired in the polymer particles.

A preferred process for preparing the aqueous dispersion of the invention is the method of miniemulsion polymerization. In this variant of emulsion polymerization, the monomer droplets are finely dispersed by means, for example, of strong shearing. The particle diameter of the monomer droplets in this case is less than 1 μm. Preferably, a costabilizer is added to the monomers, said costabilizer being characterized by low water solubility and high monomer solubility.

In the case of miniemulsion polymerization, polymerization takes place in the monomer droplets themselves.

In general, ionic and/or nonionic emulsifiers and/or protective colloids, and/or stabilizers, are used as surface-active compounds in the emulsion polymerization.

A detailed description of suitable protective colloids is given in Houben-Weyl, Methoden der organischen Chemie, Volume XIV/1, Makromolekulare Stoffe [macromolecular substances], Georg-Thieme-Verlag, Stuttgart, 1961, pp. 411 to 420. Suitable emulsifiers include anionic, cationic, and nonionic emulsifiers. Preferably, the accompanying surface-active substances used are exclusively emulsifiers whose molecular weights, unlike those of the protective colloids, are usually below 2000 g/mol. In the case where mixtures of surface-active substances are used, the individual components must of course be compatible with one another, which in case of doubt can be checked by means of a few preliminary tests. It is preferred to use anionic and nonionic emulsifiers as surface-active substances. Common accompanying emulsifiers are, for example, ethoxylated fatty alcohols (EO units: from 3 to 50, alkyl; C₈- to C₃₆), ethoxylated mono-, di- and trialkylphenols (EO units: from 3 to 50, alkyl: C₄- to C₉), alkali metal salts of dialkyl esters of sulfosuccinic acid and also alkali metal salts and ammonium salts of alkyl sulfates (alkyl: C₈- to C₁₂), of ethoxylated alkanols (EO units: from 4 to 30, alkyl: C₁₂- to C18), of ethoxylated alkylphenols (EO units: from 3 to 50, alkyl: C₄ to C₉), of alkylsulfonic acids (alkyl: C₁₂- to C₁₈) and of alkylarylsulfonic acids (alkyl: C₉- to C₁₈).

Suitable emulsifiers are also given in Houben-Weyl, Methoden der organischen Chemie, Volume 14/1, Makromolekulare Stoffe, Georg Thieme Verlag, Stuttgart, 1961, pages 192 to 208.

Commercial names of emulsifiers are, for example, Dowfax® 2 A1, Emulan® NP 50, Dextrol® OC 50, Emulgator 825, Emulgator 825 S, Emulan® OG, Texapon® NSO, Nekanil® 904 S, Lumiten® I-RA, Lumiten E 3065 etc.

The surface-active substances are usually used in amounts of from 0.1 to 10% by weight, based on all the monomers used for polymerization.

Examples of water-soluble initiators for emulsion polymerization are ammonium salts and alkali metal salts of peroxodisulfuric acid, e.g., sodium peroxodisulfate; hydrogen peroxide; or organic peroxides, e.g. tert-butyl hydroperoxide.

The systems known as reduction-oxidation (redox) initiator systems are particularly suitable.

Redox initiator systems consist of at least one, usually inorganic, reducing agent and one organic or inorganic oxidizing agent.

The oxidizing component comprises, for example, the abovementioned initiators for emulsion polymerization.

The reducing components comprise, for example, alkali metal salts of sulfurous acid, such as sodium sulfite, sodium hydrogen sulfite, alkali metal salts of disulfurous acid such as sodium disulfite, bisulfite addition compounds with aliphatic aldehydes and ketones, such as acetone bisulfite, or reducing agents such as hydroxymethanesulfinic acid and its salts, or ascorbic acid. The redox initiator systems may be used together with soluble metal compounds whose metallic component is able to exist in a plurality of valence states.

Examples of customary redox initiator systems are ascorbic acid/iron(II) sulfate/sodium peroxodisulfate, tert-butyl hydroperoxide/sodium disulfite and tert-butyl hydroperoxide/Na hydroxymethanesulfinate. The individual components, e.g., the reducing component, may also be mixtures: for example, a mixture of the sodium salt of hydroxymethanesulfinic acid with sodium disulfite.

Said compounds are used mostly in the form of aqueous solutions, the lower concentration being defined by the amount of water that is acceptable in the dispersion and the upper concentration being defined by the solubility of the respective compound in water.

In general, the concentration is from 0.1 to 30% by weight, preferably from 0.5 to 2.0%, with particular preference from 1.0 to 10% by weight, based on the solution.

The amount of the initiators is generally from 0.1 to 10% by weight, preferably from 0.2 to 5% by weight, based on all the monomers for polymerization. It is also possible to use two or more different initiators in the emulsion polymerization.

The emulsion polymerization is generally carried out at from 30 to 150° C., preferably from 50 to 90° C. The polymerization medium may consist either of water along or else as mixtures of water and water-miscible liquids such as methanol. Preference is given to the use of just water. The emulsion polymerization may be conducted either as a batch process or in the form of a feed process, including by a staged or gradient procedure. Preference is given to the feed process, in which a portion of the polymerization batch or else a polymer seed is introduced as the initial charge, this initial charge is heated to the polymerization temperature, polymerization is begun, and then the remainder of the polymerization batch is supplied to the polymerization zone continuously, in stages, or under a concentration gradient, usually by way of two or more spatially separate feed streams, of which one or more contain the monomers in pure form or in emulsified form, and polymerization is continued during these additions.

The manner in which the initiator is added to the polymerization vessel in the course of the free-radical aqueous emulsion polymerization is known to the skilled worker. It may either be included in its entirety in the initial charge to the polymerization vessel or else introduced continuously or in stages in accordance with the rate at which it is consumed in the course of the free-radical aqueous emulsion polymerization. In each individual case this will depend, in a manner known to the skilled worker, both on the chemical nature of the initiator system and on the polymerization temperature. Preferably, a portion is included in the initial charge and the remainder is supplied to the polymerization zone at the rate at which it is consumed.

In order to remove the residual monomers, it is common to add initiator after the end of the emulsion polymerization proper as well, i.e., after a monomer conversion of at least 95%.

In the case of emulsion polymerization, the product is an aqueous polymer dispersion in which the carbodiimides are not bonded covalently to the polymer by copolymerization but instead are preferably distributed, i.e., dissolved or dispersed, in the polymer particles.

The carbodiimides crosslink with carboxylic acid groups. Crosslinking may take place with carboxylic acid groups present in the same polymer. As already mentioned above, these carboxylic acid groups are preferably blocked or neutralized beforehand so that they are not reactive.

The blocking agent or neutralizing agent is removed only when crosslinking with the carbodiimide groups present is desired.

In one preferred embodiment, the carboxylic acid groups are neutralized with a base, in particular a volatile base, e.g., ammonium. The volatile base escapes, for example, at the time of subsequent use, during the drying of the applied coating composition or impregnating composition.

For crosslinking in particular, a compound having at least two carboxyl groups, referred to as crosslinker for short, may also be added to the aqueous dispersions of the invention for the purpose of crosslinking, in particular.

Said crosslinker may comprise low molecular mass compounds, e.g., polycarboxylic acids, preferably dicarboxylic acids such as adipic acid, etc.

Said crosslinker may further comprise polymers, e.g., free-radically polymerized polymers, polyadducts or polycondensates, e.g., polyurethanes or polyesters, containing carboxyl groups (referred to as polymeric crosslinker for short).

In the case of the polymeric crosslinker, the selection of the polymer depends on the subsequent use of the aqueous dispersion of the invention.

Where the aqueous dispersion is to be used as a binder, the polymeric crosslinker also acts as a binder. In one preferred embodiment the polymeric crosslinker comprises a free-radically polymerized polymer which consists of at least 40% by weight, preferably at least 60% by weight, of the above principal monomers.

The amount of the crosslinker is preferably chosen such that there is at least 0.1, in particular at least 0.5, with particular preference at least 0.8, mol of carboxyl groups per mole of carbodiimide group. Since the reaction between the carbodiimide groups and the carboxylic acid groups proceeds very readily, and in general to completion, there is no need for an excess of carboxylic acid groups. In general, the amount of the carboxylic acid groups of the crosslinker will not exceed a level of 10 mol, in particular 2 mol, per mole of carbodiimide group. A sufficient amount is in particular from 0.8 to 1.2 mol of carboxylic acid groups per mol of carbodiimido group.

The above remarks concerning the minimum amount of carboxylic acid groups apply correspondingly, if no crosslinker is added, to the amount of the (initially blocked or neutralized) carboxylic acid groups of the carbodiimide-containing polymer.

Even after the crosslinker has been added, the aqueous dispersion is stable on storage and can therefore be used as a one-component system.

Crosslinking with the crosslinker takes place only when the water is removed.

The aqueous dispersion of the invention is particularly suitable as a binder for coating compositions or impregnating compositions, e.g., for adhesives, varnishes, paints, and paper coating slips, or as a binder for fiber nonwovens, i.e., in all cases where crosslinking and an increase in internal strength (cohesion) are desired.

Depending on the intended use, the aqueous dispersion may comprise additives such as thickeners, leveling assistants, pigments or fillers, fungicides, etc.

In the case of use as an adhesive, the dispersions may comprise not only the abovementioned additives but also specific auxiliaries and additives usual in adhesives technology. These include, for example, thickeners, plasticizers, and tackifier resins, such as, for example, natural resins or modified resins such as rosin esters or synthetic resins such as phthalate resins.

Polymer dispersions which find application as adhesives include, with particular preference, alkyl (meth)acrylates as principal monomers in the polymer. Preferred applications in the adhesives field also include that of laminating adhesives, for example, for composite film lamination and high-gloss film lamination (adhesive binding of transparent film with paper or cardboard).

The glass transition temperature of the polymers (both the carbodiimide-containing polymer and, if appropriate, the polymeric crosslinker), in the case of use as an adhesive, is preferably established at levels less than 50° C., in particular less than 20° C., with particular preference less than 10° C. (ASTM 3418/82, midpoint temperature of the differential thermoanalysis).

The aqueous dispersion is also stable on storage after the crosslinker has been added.

The aqueous dispersion can be applied by customary processes to the substrates to be coated or impregnated.

Crosslinking with the crosslinker takes place with volatilization of the water. In the case of crosslinking with carboxylic acid groups of the polymer itself, a volatile neutralizing base escapes together with the water, so that crosslinking then takes place in this case as well.

The resultant coatings and impregnations have good performance properties, and in particular a high internal strength. The high strength is achieved despite the fact that the carbodiimides are covalently bonded to the polymer neither by free-radical copolymerization and, with particular preference, in no other way either. If appropriate, it may be assumed that the reaction of the carbodiimides with the crosslinker or with carboxylic acid groups of the polymer itself brings about an interleaving of polymer chains.

I. Preparation of Aqueous Dispersions

### EXAMPLE 1

300 g of styrene and 434 g of n-butyl acrylate were dispersed in an aqueous phase containing 340 g of water, 18 g of a C13 fatty alcohol with a low degree of ethoxylation, 14 g of a 45% aqueous solution of the sodium salt of the disulfonic acid of a dodecyl-substituted diphenyl ether, 42 g of a 15% strength aqueous solution of sodium lauryl sulfate, 8 g of acrylamide, and 4 g of acrylic acid (feed stream 1).

In a 2 l reactor, 8 g of a solution of 2 g of sodium persulfate in 78 g of water were added at 80° C. to 200 g of deionized water containing a fine polystyrene seed (1 part by weight per 100 parts by weight of monomer) (feed steam 2). Then feed stream 1 and the remainder of feed stream 2 were run in at 80° C. temperature over 3 hours. Reaction was continued at 80° C. for 1 hour in order to aid the conversion, after which the dispersion was cooled to room temperature and its pH adjusted to 8.5 using sodium hydroxide solution.

Particle diameter of the resulting polymer particles: 200 nm; solids content: 50.5%.

### EXAMPLE 2

The synthesis of Example 1 was repeated except that 2 parts by weight (per 100 parts by weight of monomers) of the methyldiglycol-modified carbodiimide of the formula I:

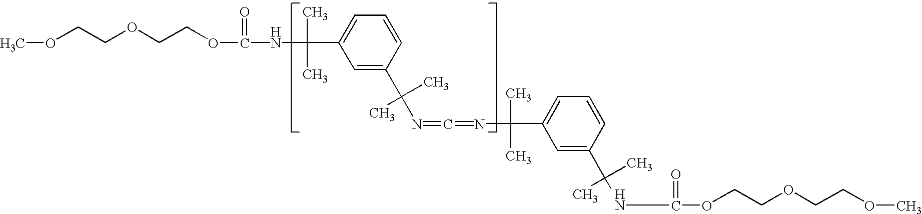

were dissolved in the monomers for dispersion. As in Example 1, the acrylic acid in feedstream 1 was not neutralized. It therefore reacts completely at this stage with the carbodiimido groups, so that there are no carbodiimide groups in the subsequent polymer.

Particle diameter of the resulting polymer particles: 190 nm; solids content: 49%.

### EXAMPLE 3

The synthesis of Example 2 was repeated except that the aqueous phase was neutralized to a pH of 7 using sodium hydroxide solution before the monomer mixture was added.

Particle diameter of the resulting polymer particles: 195 nm; solids content: 49.5%.

### EXAMPLE 4

The synthesis of Example 3 was repeated except that the aqueous phase was neutralized to a pH of 9 using ammonia before the monomer mixture was added.

Particle diameter of the resulting polymer particles: 188 nm; solids content: 49%.

II. Performance Testing

Determination of tensile strength and elongation at break:

In accordance with DIN 53504 and using a tensile testing machine, the tensile strength and elongation at break of the films produced from the aqueous dispersions were measured.

In order to assess the crosslinking efficiency, temperature-dependent measurements of the storage modulus E′ were conducted. An increased storage modulus in this case indicates crosslinking of the polymer film. In the table, the value for E′ at 150° C. is stated in pascals.

| | Tensile strength | Elongation at | |
|---|---|---|---|
| Example | (N/mm²) | break (%) | E′ |
| 1* | 2.56 | 1024 | 10,000 |
| 2* | 3.17 | 653 | 2000 |
| 3 | 2.1 | 1172 | 60,000 |
| 4 | 3.48 | 1051 | 100,000 |

*for comparison

III. Preparation of Miniemulsion Polymer

A reaction vessel with stirrer was charged with an aqueous emulsifier solution. A solution of the carbodiimide of formula II in the monomers for polymerization (monomer/carbodiimide solution) was added to this initial charge over the course of 2 minutes. This was followed by stirring for 10 minutes. The carbodiimide-containing monomer emulsions were homogenized by means of ultrasound so as to give miniemulsions having a particle diameter of less than 1 μm (=feedstream 1). The initial charge 2 was charged to a polymerization vessel and heated to 80° C. with stirring. Following the heating of initial charge 2 to 80° C., the feedstreams 1, 2 and 3 were commenced simultaneously and were introduced to the initial charge 2 over the course of 3 hours, ith stirring. Following the addition of feedstreams 1 and 2 to the initial charge 2, polymerization was continued at 80° C. for 30 minutes and then the batch was cooled to 25° C.

| | | |
|---|---|---|
| Feedstream 1: | 1547.1 g | H₂O |
| | 21 g | Steinapol NLS (Na lauryl sulfate) |
| | | (emulsifier) |
| | 105 g | Carbodiimide (formula II) |
| | 840 g | n-Butyl acrylate |
| | 210 g | Methyl acrylate |
| Initial | 375 g | Water |
| charge 2: | | |
| | 3.15 g | Ethylenediaminetetraacetic acid- |
| | | iron (III)-sodium salt |
| Feedstream 2: | 199.5 g | Water |
| | 10.5 g | Na-persulfate |
| Feedstream 3: | 42 g | 10% NaOH |

II

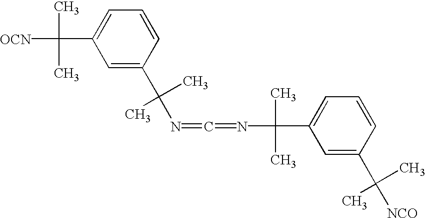

IV. Testing of the Miniemulsion Polymer as an Adhesive for High-gloss Film Lamination

High-gloss film lamination with card (chromoduplex card) and polypropylene (corona-pretreated) and with card and cellulose acetate film

A crosslinker containing carboxylic groups was added to the miniemulsion obtained in III. The crosslinker was an aqueous dispersion of a polyacrylate synthesized with 2% by weight of acrylic acid (solids content 55% by weight, pH 6.5). The dispersion obtained was then used as the adhesive.

The pretreated side of the polypropylene film (PP) and, respectively, of the acetate film was coated with adhesive. After drying with cold air, the card was applied and was rolled on using laboratory lamination roller. The laminates, cut to size, were pressed in a roller press.

The adhesion was tested by peeling the film from the card at an angle of approximately 180 degrees.

Evaluation:

1=paper or paint tear over full area

2=partial paper or paint tear

3=good adhesion with adhesive fracture of card or film (AC, AF)

4=poor adhesion with AC or AF

5=no adhesion to card or film

In order to determine the groove stability, the laminated samples were grooved 1 week and 6 weeks after being produced as above.

Assessment of the grooving:

1=groove is fully satisfactory

2=groove has opened slightly at particular points

3=groove has opened significantly at particular points

4=groove is completely open

For comparison, Acronale®A 3105 was tested in the same way. This is a crosslinking emulsion polymer which finds application as a high-gloss film laminating adhesive.

| | | | | | Groove | |
|---|---|---|---|---|---|---|
| | Base | Adhesion after | | | stability after | |
| Results: | material | 24 h | 1 week | 6 weeks | 1 week | 6 weeks |
| Miniemulsion¹⁾ | oPP film | 1 | 1 | 1 | 1 | 1-2 |
| | Acetate | 1 | 1 | 1 | 1 | 1-2 |
| | film | | | | | |
| Miniemulsion²⁾ | oPP film | 1 | 1 | 1 | 1 | 1 |
| | Acetate | 1 | 1 | 1 | 1 | 1 |
| | film | | | | | |
| Acronal A | oPP film | 1 | 1 | 1 | 2 | 2-3 |
| 3105 | Acetate | 1 | 1 | 1 | 2 | 2-3 |
| | film | | | | | |

¹⁾1 parts by weight of the miniemulsion were mixed with 1 part by weight of the crosslinker dispersion.
²⁾2 parts by weight of the miniemulsion were mixed with 1 part by weight of the crosslinker dispersion.

We claim:

1. An aqueous dispersion of a polymer synthesized from free-radically polymerizable compounds (monomers), wherein the dispersed polymer particles comprise compounds containing carbodiimide groups (carbodiimides for short) and the carbodiimides are present in solution or dispersion in the polymer particles.

2. An aqueous dispersion as claimed in claim 1, wherein the carbodiimides have a water solubility of less than 50 g per liter of water (21° C.).

3. An aqueous dispersion as claimed in claim 1 or 2, wherein the carbodiimides have a number-average molecular weight Mn of from 100 to 10,000 g/mol.

4. An aqueous dispersion as claimed in any of claims 1 to 3, wherein the carbodiimides contain from 1 to 20 carbodiimide groups.

5. An aqueous dispersion as claimed in any of claims 1 to 4, wherein the carbodiimides contain isocyanate groups or their reaction products of alcohols, thiols, or primary or secondary amines.

6. An aqueous dispersion as claimed in any of claims 1 to 5, wherein the carbodiimides contain no ionic groups and no polyalkylene oxide groups having more than 5 ethylene oxide units.

7. An aqueous dispersion as claimed in any of claims 1 to 6, wherein the carbodiimides consist of hydrocarbon groups, carbodiimide groups, and, if desired, isocyanate groups, and/or their reaction products with hydroxyl, thiol, or primary or secondary amino groups.

8. An aquoeus dispersion as claimed in any of claims 1 to 7, wherein there are from 0.0001 to 2 mol of carbodiimide groups per kg of polymer.

9. An aqueous dispersion as claimed in any of claims 1 to 8, wherein the polymer is an emulsion polymer.

10. An aqueous dispersion as claimed in any of claims 1 to 9, wherein the emulsion polymer is obtainable by emulsion polymerization of monomer droplets, emulsified in water, having a particle diameter of up to 50 μm and carbodiimides are present in solution or dispersion in these monomer droplets.

11. An aqueous dispersion as claimed in any of claims 1 to 10, wherein the emulsion polymer is obtainable by the method of miniemulsion polymerization, in which the water-emulsified monomer droplets have a particle diameter up to 1 μm and the carbodiimides are present in solution or dispersion in these monomer droplets.

12. An aqeuous dispersion as claimed in any of claims 1 to 11, wherein the polymer consists in total of at least 40% by weight of principal monomers selected from C1 to C20 alkyl (meth)acrylates, vinylaromatic compounds having up to 20 carbon atoms, vinyl esters of carboxylic acids having 1 to 20 carbon atoms, ethylenically unsaturated nitrites, vinyl ethers of alcohols containing 1 to 10 carbon atoms, vinyl halides, nonaromatic hydrocarbons having 2 to 8 carbon atoms and having one or two conjugated double bonds, or mixtures of these monomers.

13. An aqueous dispersion as claimed in any of claims 1 to 12, wherein carboxylic acid groups of the polymer are at least partially neutralized.

14. An aqueous dispersion as claimed in any of claims 1 to 13, wherein the aqueous dispersion comprises as crosslinker a compound having at least two carboxyl groups.

15. An aqueous dispersion as claimed in any of claims 1 to 14, wherein the crosslinker comprises a free-radically polymerized polymer, a polyadduct, or a polycondensate.

16. The use of an aqueous dispersion as claimed in any of claims 1 to 15 as a binder for a coating composition or impregnating composition.

17. The use of an aqueous dispersion as claimed in any of claims 1 to 15 as a binder in adhesives, varnishes, paints, or paper coating slips, or as a binder for fiber nonwovens.

18. The use of an aqueous dispersion as claimed in any of claims 1 to 15 as a binder for laminating adhesives, especially for high-gloss film laminating adhesives.

19. A coating composition or impregnating composition comprising an aqeous dispersion as claimed in any of claims 1 to 15.

20. A substrate coated with an aqueous dispersion as claimed in any of claims 1 to 15.
